(19) United States
(12) Patent Application Publication
(10) Pub. No.: US 2008/0233344 A1
(43) Pub. Date: Sep. 25, 2008

(54) Airplane component as well as method for manufacturing an airplane component

(76) Inventors: Burkhart Grob, Bad Wörishofen (DE); Micheler Heinz, Tussenhausen-Mattsies (DE)

Correspondence Address: JACOBSON HOLMAN PLLC, 400 SEVENTH STREET N.W., SUITE 600, WASHINGTON, DC, 20004, US

(21) Appl. No.: 11/703,214

(22) Filed: Feb. 7, 2007

(30) Foreign Application Priority Data
Feb. 7, 2006 (DE) 10 2006 005 754.6
Sep. 22, 2006 (DE) 10 2006 044 842.1

(51) Int. Cl. B32B 3/12; B29C 65/48

(52) U.S. Cl. 428/116; 156/295

(57) ABSTRACT

The invention refers to a method for manufacturing an airplane component, as well as the airplane component itself. According to the invention it is suggested here that a side of laminate is coated with a connection resin, and a honeycomb core is placed upon the coated laminate side, and the connection resin rises along the honeycomb walls of the honeycomb core and forms a fastening meniscus.

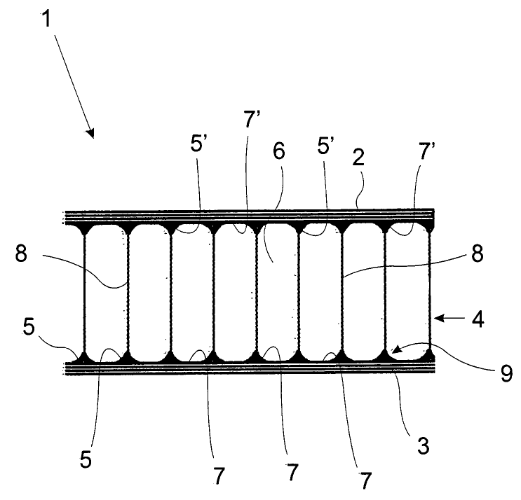

### BACKGROUND OF THE INVENTION

The invention refers to a component, in particular an airplane component, as well as a method for manufacturing a component, in particular an airplane component. It is known to build airplane components, as for example fuselage or wings of the airplane, from synthetic material. In order to save weight of the airplane it is known to realise the airplane components in a synthetic composite structure. The synthetic composite structure has a sandwich construction with an exterior laminate, an interior laminate and core material of honeycomb material arranged in between. It is also known to manufacture airplane components of metal, for example aluminium.

It is known in motor racing sport to manufacture components of cars and motorboats in synthetic composite structure.

### SHORT SUMMARY OF THE INVENTION

It is an object of the invention to provide a method for manufacturing a component of the type described in the beginning as well as an airplane component in such away that in particular with airplane components made with synthetic composite structure a stability as high as possible is reached while at the same time the weight of the components is as low as possible.

In order to solve this problem the invention comes from a method for manufacturing an airplane component in sandwich construction wherein a laminate side is coated with a connection resin, and a honeycomb core is placed upon the coated laminate side, and the connection resin rises at the honeycomb walls of the honeycomb core and forms a fastening meniscus.

Honeycomb means a two-dimensional honeycomb material which, seen in cross section, in a synthetic sandwich structure forms the core layer and therefore is called honeycomb core. The construction of the honeycomb core will be described later on.

Furthermore the invention suggests an airplane component which consists of a honeycomb core arranged between an interior laminate and an exterior laminate, the honeycomb core having a number of honeycomb walls orientated angularly, in particular rectangularly, to the laminate surface, and a fastening meniscus, preferably consisting of connection resin, being arranged in the contact region of the honeycomb walls at the interior or exterior laminate.

The method according to the invention for manufacturing an airplane component comes from the fact that the corresponding airplane component is manufactured in a negative mould. The negative mould is here adapted to the desired form of the airplane component, for example a fuselage or wing.

In the method for manufacturing an airplane component according to the invention here, first of all, the exterior laminate layer impregnated or saturated with resin is placed in a negative mould. The laminate side opposite the negative mould is, after that, connected with honeycomb core material. Before the honeycomb core is put on this laminate side the laminate is coated with a connection resin. In the connection plane of the honeycomb core with the laminate this connection resin crawls, starting at the laminate, along or up the honeycomb bridges or honeycomb walls and forms a fastening meniscus in a jellying process so that the glueing surface, which actually is in obtuse contact with the wall at the laminate, is enlarged considerably, and furthermore also seals the honeycomb cell. Via the fastening meniscus a mechanically stable connection is created from the (interior or exterior) laminate to the honeycomb core.

By means of this method according to the invention the glueing surface is enlarged considerably, and thus also the stability is increased, as not only a one-dimensional contact surface of the honeycomb wall of the honeycomb core forms on the laminate but the complete corner region is filled by the fastening meniscus which is in particular designed flute-like, and thus a much larger glueing or connecting surface is created.

The method according to the invention thus is the base for the manufacture of a mechanically produced, in particular in synthetic composite structure in hand laminate low pressure method, airplane component which has much more improved qualities, in particular stability and solidity, and nevertheless is expressly light weight.

It is clear that, according to the method of the invention, not only one laminate side has to be connected with a side of the honeycomb core but, of course, interior and exterior laminate can be connected with the honeycomb core accordingly. This will be described in detail later on.

The laminate is designed as fiber composite material which is produced by clever assembling a matrix and different fibers. As matrix here, for example, a resin, for example epoxy resin or the like, is used. As reinforcing fibers, for example, glass, carbon or even aramide or other synthetic fibers are used. The fiber material comes here for example in mats, and is saturated with the resin, which is usually realised in a two-component system.

It is particularly convenient here that the fiber material of the fiber composite material consists of glass or carbon fiber as these materials absorb only little moisture. In other fields of application, however, also the use of aramide fibers is possible.

The connection resin layer applied to the laminate leads to a high stability as just in the otherwise very fragile connection region of the honeycomb wall being in obtuse contact with the laminate side now a high solidity is created.

Cleverly as connection resin the same resin is used as it is also used in the fiber composite material. It is thus in a first modification according to the invention identical with the material of the matrix of the composite material, for example, epoxy resin is used for that. However, the invention is not restricted to that. Of course, all other materials can be used which show similar qualities, however, are not identical with the material of the matrix. A material of the same design has, of course, the advantage that a better composite, in particular a one piece composite, with the laminate can be produced.

It has been found here that the connection resin is preferably convenient in a density of about 50 to 150 g/m in particular preferred about from 70 to 100 g/m². This share of connection resin has been investigated in test sequences, and combines here an optimal connection of the honeycomb material with the laminate while the weight is low.

Between the application of the connection resin and the further processing of the laminate a drying period is provided in order to give the resin a sufficiently high viscosity, and thus to prevent an uneven spreading. It has been observed that the forming of the fastening meniscus is based on the capillary effect or the adhesion of the connection resin to the honeycomb wall of the honeycomb material. The connection resin running or rising along the honeycomb wall, of course, leads to a certain, irregular amount in the surface of the laminate. A higher viscosity prevents here an intolerable, uneven spreading; the viscosity may be determined through the drying period depending on the selected connection resin.

In a preferred modification of the invention it is provided that the connection resin is inked in another colour as the laminate. By means of that a simple optical test of the even and complete saturation of the laminate with the connection resin is achieved. It has to be taken into consideration here that the connection resin has a thickness of only a few tenth of millimeters. Advantageously the connection resin is inked white for example, in contrast to the laminate which is dark because of the preferred carbon fiber mesh. Such a high contrast can be discerned easily in the optical test.

In another modification according to the invention it is also possible to coat with the connection resin also or only the honeycomb core side in contact with the laminate. In such a procedure also a fastening meniscus is formed between the honeycomb wall and the laminate.

The method according to the invention is not restricted to the fact that the honeycomb core is above the laminate side, even in a lateral or upside down arrangement, in particular in the realisation of a sandwich structure, the result is that also the connection resin applied to the top side of the laminate “rises downstairs”, and thus forms a fastening meniscus. That means that the fastening meniscus forms, independently on the actual geometric position between the honeycomb wall and the laminate. In any case the connection resin rises along the honeycomb walls, either from the bottom to the top or from the top to the bottom.

It has been described that preferably the exterior laminate layer is put in the negative mould, and then the airplane component is built from the exterior to the interior in the negative mould. It is clear that the invention can also be realised in another way, that means also when the interior laminate layer is placed in the negative mould the method according to the invention can be used in the same way.

In a modification according to the invention it has been found here to be convenient to provide at the outside a primer layer on the exterior laminate. This is achieved by applying a suitable jelly-like facing as first layer (after an anti-adhering layer) in the negative mould. On top of this primer layer, after that, as described, the exterior laminate is built.

After the end of the described drying period then it is provided that the honeycomb core with its very low wall thickness is pressed in the laminate and connected permanently. The honeycomb core is here with comparable low force, for example by rolling-in or sucking-off, pressed in the laminate where then by means of the adhesion or capillary effect the fastening meniscus forms.

The honeycomb core consists of a two-dimensional honeycomb material where the honeycombs have different geometric shapes, for example squares or hexagons. The honeycomb walls consist, for example, of polyamide or aramide fibers saturated with phenyl resin and, after that manufactured into paper. Also polyamide paper phenolic resin bound honeycomb cores are known. These materials are characterised by a high stiffness and a corresponding low weight. Seen in section the single honeycombs have a cross section surface of about 20 to 80 mm. Preferably a honeycomb core is used with a cross section surface of the single honeycombs of about 30 to 40 mM.

Conveniently it is provided that the exterior laminate (which is, if necessary, put in the negative mould) as well as the interior laminate are both coated with connection resin, and then, in a relatively quick sequence, the honeycomb core is placed on the exterior laminate in the negative mould, and, immediately after that, the interior laminate is placed on the already placed honeycomb core.

By rolling-in to the backside then at the same time the honeycomb core is connected with the interior as well as the exterior laminate in such a way that the respective end regions of the honeycomb walls are pressed in the connection resin layers pointing at the honeycomb core of the interior or exterior laminate.

Eventually the complete sandwich structure is sealed airtight with a foil, and then provided with a vacuum with a low pressure of 0.7 to 0.9 Bar and pressed. The foil here restricts in interaction with the negative mould the space which has to be evacuated.

In an advantageous embodiment of the invention it is provided that connecting the interior laminate with the honeycomb core and connecting the honeycomb core with the exterior laminate takes place in vacuum. During hardening a low pressure of about 0.7 to 0.9 Bar is provided in which the complete airplane component is placed. In each single honeycomb thus a low pressure is generated which acts advantageously on the entire sandwich structure. Here cleverly the vacuum is connected before a connection of the two laminates with the honeycomb core, and, after that, the three elements are assembled. It has been found here that already with a low thickness, for example of three layers of the fiber compound material, in the hardened laminate a gas passage could not be detected anymore, and thus also the air column in a honeycomb cell is under a corresponding low pressure. Here the applied connection resin layer does not serve only for a corresponding mechanically loaded connection of the single honeycomb walls with the exterior or interior laminate but it also seals the single honeycomb cells against each other and also against the surroundings.

It is possible here that the pressure within the honeycomb cell after the hardening of the component is between 0.1 and 0.9 Bar.

It has been found that an airplane component manufactured according to the invention remains stable even with a difference pressure of more than 4 Bar, and thus a large mechanic security and stability, for example for the construction of airplane components or airplanes, is available.

In addition to the already described methods for sealing the honeycomb cores the structure was protected against moisture.

The problem is also solved by a component, in particular an airplane component, which comprises a honeycomb core arranged between an interior laminate and an exterior laminate, the honeycomb core having a number of honeycomb walls orientated angularly, in particular rectangularly, to the laminate surface, and a fastening meniscus, preferably made of connection resin, being arranged in the contact region of the honeycomb wall at the interior or exterior laminate.

The honeycomb core is conveniently a surface honeycomb material, preferably with a thickness of 5 mm to 50 mm, with a number of honeycomb cells. The honeycomb core has preferably a number of honeycomb cells with a low pressure of about 0.1 to 0.9 Bar.

The honeycomb cells comprise advantageously honeycomb walls of polyamide or aramide fibers saturated with phenolic resin and manufactured to paper.

The manufacture method according to the invention for an airplane component leads to a highly loadable and extremely lightweight airplane component. Here by means of a simple procedure step, namely applying the connection resin, which can be carried out in a suitable way two-dimensional and by machine, a secure and effective connection between the delicate honeycomb walls of the honeycomb core and the interior or exterior laminate is provided. By means of the relatively small additional effort of applying the connection resin thus a large effect, namely a high stability and sealing of the airplane component, is reached. The honeycomb core of the component is advantageously sealed essentially by the connection resin.

Furthermore the airplane component according to the invention offers even more advantages. For example, material fatigue was not observed. The airplane component is not prone to corrosion, either. Hammering of rivets is also avoided as no rivets are used. Thus there is no risk of forming creeping fissures.

Besides the considerably improved static qualities the airplane component according to the invention is also marked by its heat insulation because of the sandwich structure as well as sound insulation. Also repairs of damages, for example of the outside shell of an airplane which is equipped with the component according to the invention, are easily possible.

Furthermore the invention comprises also an airplane with a pressure cabin, wherein in particular the pressure cabin is formed, at least partly, by an airplane component as described.

In this connection it is pointed out specifically that all features and characteristics described with reference to the airplane component, but also methods may be transferred accordingly, also with reference to the formulation of the method according to the invention, and can also be used in the sense of the invention and are seen also as disclosed. The same also goes vice versa, that means, characteristics only mentioned with reference to the method, constructive, that means device, characteristics may also be taken into consideration and be claimed in the frame of the claims for the airplane component according to the invention or the airplane according to the invention, and count also as part of the invention and the disclosure.

### SHORT DESCRIPTION OF THE VIEW IN THE DRAWING

The invention is shown schematically in the single drawing.

Here in a section the airplane component according to the invention is shown.

### DETAILED DESCRIPTION OF THE PREFERRED EMBODIMENT

In the single FIGURE the airplane component 1 according to the invention is shown in a vertical section. The representation has a full scale of about 1:1.

The airplane component 1 here consists of an interior laminate 2, an exterior laminate 3, and a honeycomb core 4 arranged between interior laminate 2 and exterior laminate 3.

The interior as well as the exterior laminate 2, 3 here consist of a number layers of fiber mats arranged one above the other, for example of glass or carbon fibers, which are connected to each other by a matrix. As matrix, for example, a resin, a synthetic or epoxy resin is provided. Interior as well as exterior laminate 2, 3 are here indeed realised in multiple layers, wherein in particular the innermost or also the outermost layers of the laminates may have additional qualities by integrating additional materials.

The honeycomb core 4 has a height of about 5 mm to 50 mm. Seen in a top view the honeycomb core 4 consists of a number of tetragonal or hexagonal designed honeycomb cells 6 arranged one next to the other. The design of the honeycombs here is, by the way, possible in any way.

The single honeycomb cells 6 are each separated from each other by the honeycomb walls 8. The single honeycomb cells 6 are closed by the interior laminate 2 or the exterior laminate 3.

The side of the interior laminate 2 or the exterior laminate 3 facing the honeycomb core 4 is two-dimensionally coated or covered with a layer of connection resin 7. The connection resin here is preferably identical with the matrix material of the composite material of the interior laminate 2 or the exterior laminate 3. It is, of course, possible in addition to that to use other material than the connection resin 7 which can be connected, on the one hand, compatibly with the interior laminate 2 or the exterior laminate 3, and, on the other hand, guarantees a sufficient mechanical stability as high as possible.

The honeycomb wall 8 is pressed with a certain power to the respective laminate in such a way that the end region 9 of the honeycomb wall 8 is pressed in the layer of connection resin 7. Here, of course, all end regions of the honeycomb walls 8 are pressed in the same way in the connection resin 7. The connection resin 7 here is not yet completely hardened, however, not so liquid as shortly after applying. By means of a suitable drying period after applying of the connection resin the viscosity may be set, and thus the design of the fastening meniscus 5, 5′ which form at the side next to the honeycomb wall 8 in the end region 9 of the honeycomb wall. It is convenient here that the connection resin 7 rises automatically on the honeycomb wall 8 to the top or the bottom, that means it moves or rises along, and thus forms the design of the fastening meniscus, and forms a mechanical connection which can be loaded.

At the same time the connection resin 7 seals the gap region between the bottom edge of the honeycomb wall 8 to the respective laminate 2, 3 gas-tight. The single honeycomb cells 6 thus are independent from each other and gas-tight.

According to the manufacturing method according to the invention it has been found here that the fastening meniscus 5, 5′ are formed at the exterior laminate 3, in this example on the bottom, as well as at the interior laminate 2 arranged on top (here fastening meniscus 5′).

Although the invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. Method for manufacturing a component (1), in particular an airplane component (1), wherein one laminate side is coated with a connection resin (7), and a honeycomb core (4) is placed upon the coated laminate side, and the connection resin (7) rises along the honeycomb walls (8) of the honeycomb core (4) and forms a fastening meniscus (5), or the connection resin (7) is applied to at least one side, in particular two sides facing each other of a honeycomb core (4), and, after that, the coated side is put on a laminate side and the connection resin (7) is pressed, and the connection resin (7) rises along the honeycomb walls (8) of the honeycomb core (4) and forms a fastening meniscus (5).

2. Method according to claim 1, characterised in that a laminate side of an exterior laminate opposite a negative mould of a corresponding airplane component is coated with connection resin (7), and an interior laminate (2) on the side facing the honeycomb core (4) is coated with connection resin (7).

3. Method according to claim 1, characterized in that the exterior laminate (3) and/or the interior laminate (2) is produced with several, preferably three layers of fiber mats, in particular glass fibers or carbon fibers.

4. Method according to claim 1, characterized in that the exterior laminate (3) and/or the interior laminate (2) is produced with several, preferably three layers of fiber mats, in particular glass fibers or carbon fibers, and the fiber mat layers are saturated with a two-component synthetic system, preferably epoxy resin, for producing a fiber reinforced synthetic material.

5. Method according to claim 1, characterized in that as connection resin (7) a resin identically with the resin of the fiber reinforced synthetic material of the exterior laminate (3) and/or interior laminate (2), in particular epoxy resin, is used.

6. Method according to claim 1, characterized in that the connection resin (7) is applied with a density of about 50 g/m² to 150 g/m², in particular preferred of 70 g/m² to 100 g/m².

7. Method according to claim 1, characterized in that a drying period of the connection resin (7) after the application on a laminate side is waited for.

8. Method according to claim 1, characterised in that the connection resin is inked in another colour than the laminate (2, 3), preferably with a high contrast, in particular with a black laminate in a white colour, and that the connection resin (7) is applied after that on the laminate side.

9. Method according to claim 1, characterised in that the connection resin is applied at least partly on up to vertical sides.

10. Method according to claim 1, characterised in that the honeycomb core (4) is pressed in the laminate side coated with connection resin (7), preferably by rolling-in or sucking-off.

11. Method according to claim 1, characterised in that the component (1) is sealed airtight with a foil and charged with low pressure, preferably between 0.7 to 0.9 Bar, and is hardened as well as in particular pressed.

12. Method according to claim 1, characterised in that, after an anti-adhesion layer, a primer layer is applied on a negative mould upon which the exterior laminate (3) is built.

13. Component (1), in particular airplane component, comprising a honeycomb core (4) arranged between an interior laminate (2) and an exterior laminate (3), wherein the honeycomb core (4) has a number of angularly, in particular orientated rectangularly to the laminate surface, honeycomb walls (8), and, in the contact region of the honeycomb wall (8) with the interior or the exterior laminate (2, 3), a fastening meniscus (5) is arranged, preferably made of connection resin (7).

14. Component according to claim 13, characterised in that the honeycomb core (4) is a two-dimensional honeycomb material, preferably with a thickness of 5 mm to 50 mm, with a number of honeycomb cells (6).

15. Component according to claim 13, characterised in that the honeycomb core (4) is essentially sealed by the connection resin (7).

16. Component according to claim 13, characterised in that the honeycomb core (4) comprises a number of honeycomb cells (6) which have a low pressure of about 0.1 to 0.9 Bar.

17. Component according to claim 13, characterised in that the honeycomb core (4) comprises a number of honeycomb cells, and the honeycomb cells (6) comprise honeycomb walls (8) of polyamide or aramide fibers, which are saturated with phenyl resin and manufactured into paper.

18. Component according to claim 13, characterised in that the exterior laminate (3) and the interior laminate (2) have at least three layers of fibers, in particular layers of glass fibers or carbon fibers.

19. Component according to claim 13, characterised in that the connection resin (7) has another colour than the laminate, preferably white colour.

20. Airplane with a pressure cabin, wherein the pressure cabin is formed at least partly by a component according to claim 13.
